(19) United States
(12) Patent Application Publication
(10) Pub. No.: US 2026/0171664 A1
(43) Pub. Date: Jun. 18, 2026

(54) APPARATUS HAVING ANTENNA ARRAYS

(71) Applicant: Nokia Solutions and Networks Oy, Espoo (FI)

(72) Inventor: Andrei MALKOV, Espoo (FI)

(21) Appl. No.: 19/419,386

(22) Filed: Dec. 15, 2025

(30) Foreign Application Priority Data
Dec. 18, 2024 (GB) 2418546.4

(51) Int. Cl. H01Q 1/52

(52) U.S. Cl. CPC H01Q 1/525; H01Q 1/523

(57) ABSTRACT

An apparatus, comprising: a transmit antenna array comprising a plurality of transmit antenna array elements; a receive antenna array comprising a plurality of receive antenna array elements; a suppression antenna array comprising a plurality of suppression antenna array elements; and a signal generator configured to generate suppression antenna array element drive signals for the suppression antenna array elements to generate a compensating electromagnetic field to reduce interference received by the plurality of receive antenna array elements from the plurality of transmit antenna array elements.

### TECHNOLOGICAL FIELD

Various example embodiments relate to an apparatus having antenna arrays.

### BACKGROUND

Apparatus having antenna arrays for use in, for example, a wireless telecommunications network are known. Although such apparatus exist, they can have shortcomings. Accordingly, it is desired to provide an improved apparatus.

### BRIEF SUMMARY

The scope of protection sought for various example embodiments of the invention is set out by the independent claims. The example embodiments and features, if any, described in this specification that do not fall under the scope of the independent claims are to be interpreted as examples useful for understanding various embodiments of the invention.

According to various, but not necessarily all, example embodiments of the invention there is provided an apparatus, comprising: a transmit antenna array comprising a plurality of transmit antenna array elements; a receive antenna array comprising a plurality of receive antenna array elements; a suppression antenna array comprising a plurality of suppression antenna array elements; and a signal generator configured to generate suppression antenna array element drive signals for the suppression antenna array elements to generate a compensating electromagnetic field to reduce interference received by the plurality of receive antenna array elements from the plurality of transmit antenna array elements.

According to various, but not necessarily all, example embodiments of the invention there is provided a method, comprising: generating suppression antenna array element drive signals for a plurality of suppression antenna array elements of a suppression antenna array of an apparatus comprising a transmit antenna array comprising a plurality of transmit antenna array elements, a receive antenna array comprising a plurality of receive antenna array elements and the plurality of suppression antenna array elements to generate a compensating electromagnetic field to reduce interference received by the plurality of receive antenna array elements from the plurality of transmit antenna array elements.

According to various, but not necessarily all, example embodiments of the invention there is provided a computer program comprising instructions stored thereon for performing at least the following: generating suppression antenna array element drive signals for a plurality of suppression antenna array elements of a suppression antenna array of an apparatus comprising a transmit antenna array comprising a plurality of transmit antenna array elements, a receive antenna array comprising a plurality of receive antenna array elements and the plurality of suppression antenna array elements to generate a compensating electromagnetic field to reduce interference received by the plurality of receive antenna array elements from the plurality of transmit antenna array elements.

According to various, but not necessarily all, example embodiments of the invention there is provided a non-transitory computer readable medium comprising program instructions stored thereon for performing at least the following: generating suppression antenna array element drive signals for a plurality of suppression antenna array elements of a suppression antenna array of an apparatus comprising a transmit antenna array comprising a plurality of transmit antenna array elements, a receive antenna array comprising a plurality of receive antenna array elements and the plurality of suppression antenna array elements to generate a compensating electromagnetic field to reduce interference received by the plurality of receive antenna array elements from the plurality of transmit antenna array elements.

Further particular and preferred aspects are set out in the accompanying independent and dependent claims. Features of the dependent claims may be combined with features of the independent claims as appropriate, and in combinations other than those explicitly set out in the claims.

Where an apparatus feature is described as being operable to provide a function, it will be appreciated that this includes an apparatus feature which provides that function or which is adapted or configured to provide that function.

### BRIEF DESCRIPTION

Some example embodiments will now be described with reference to the accompanying drawings in which:

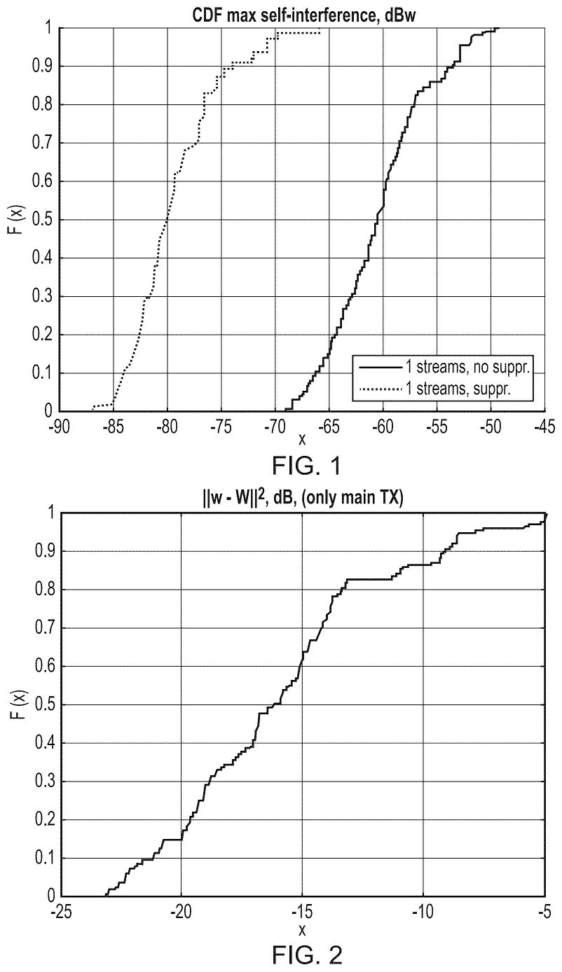

FIG. 1 illustrates an empirical cumulative distribution function (CDF) of self-interference power at the most affected RX antenna element with and without beam nulling;

FIG. 2 illustrates an empirical CDF of the squared L2 norm of the difference between original and transformed beamforming vector;

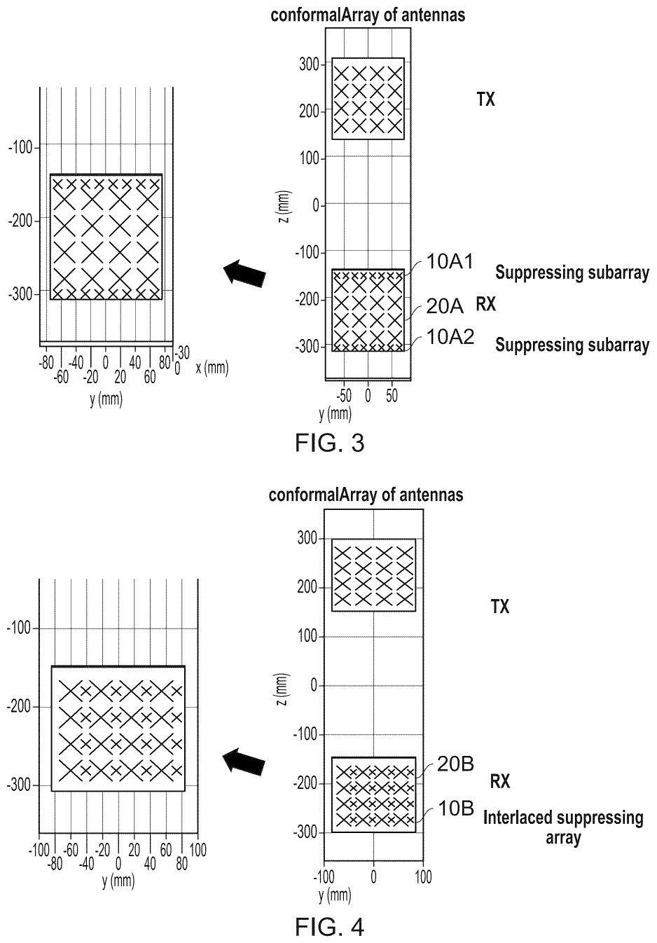

FIG. 3 illustrates antenna configuration 1 according to one example embodiment;

FIG. 4 illustrates antenna configuration 2 according to one example embodiment;

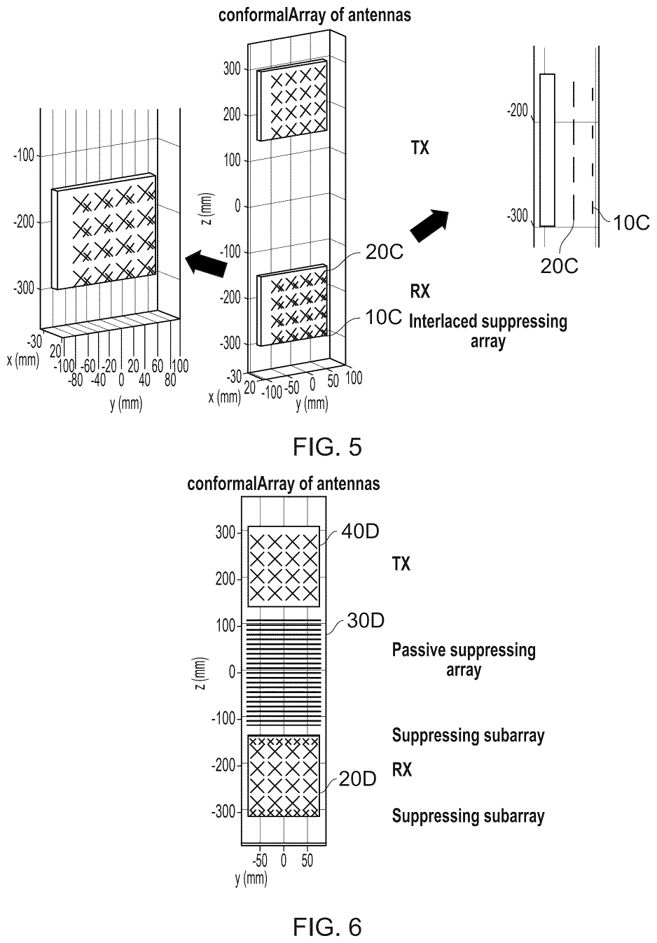

FIG. 5 illustrates antenna configuration 3 according to one example embodiment;

FIG. 6 illustrates an antenna configuration combined with a wave trap according to one example embodiment;

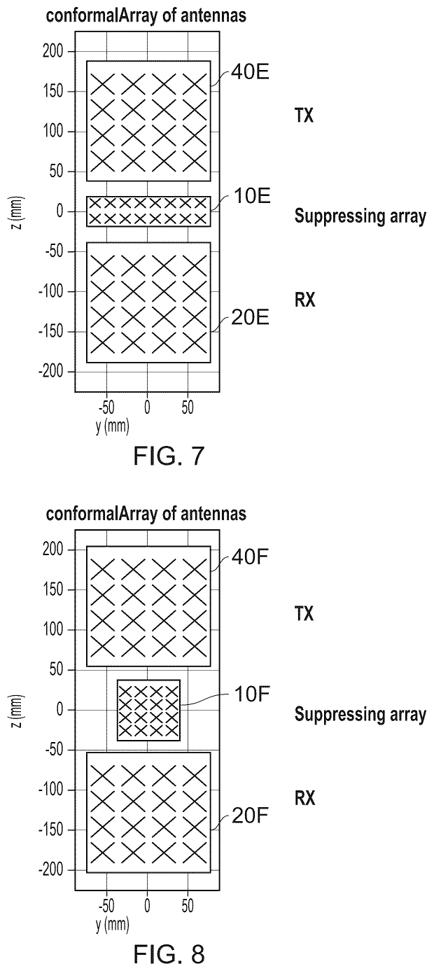

FIG. 7 illustrates an antenna configuration according to one example embodiment;

FIG. 8 illustrates an antenna configuration according to one example embodiment;

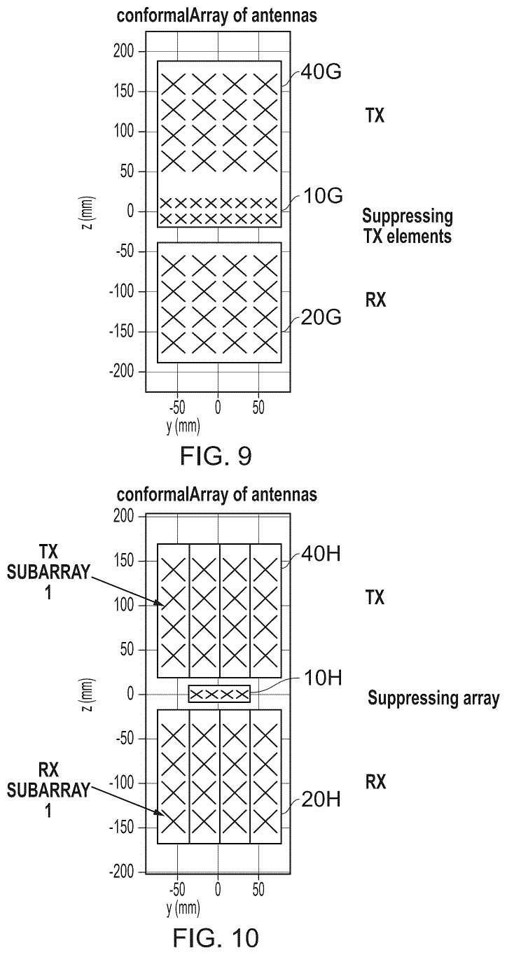

FIG. 9 illustrates an antenna configuration according to one example embodiment;

FIG. 10 illustrates an antenna configuration according to one example embodiment;

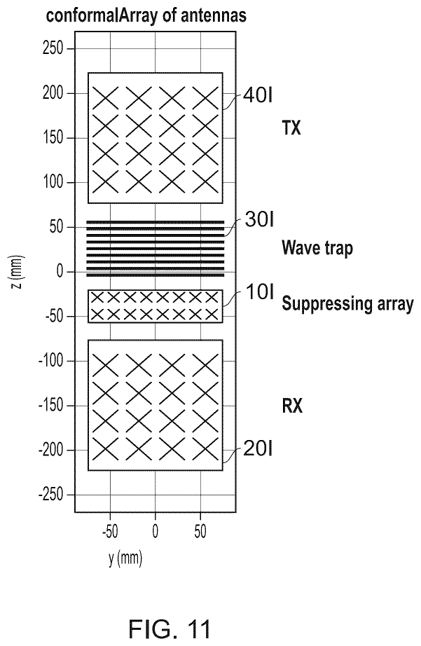

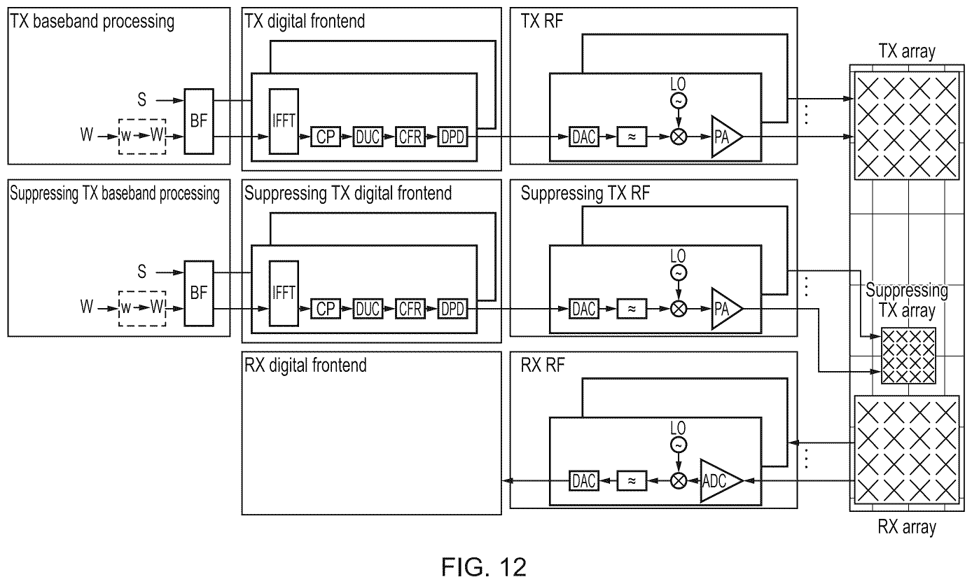

FIG. 11 illustrates an antenna configuration according to one example embodiment;

FIG. 12 illustrates schematically a front end for driving the antenna according to one example embodiment;

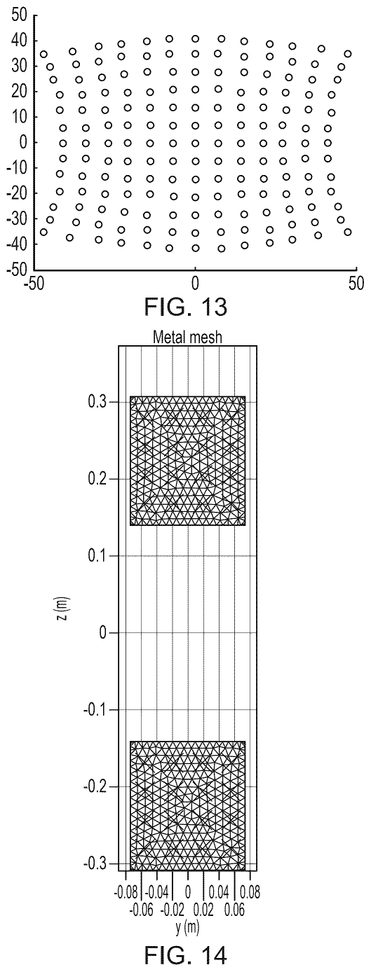

FIG. 13 illustrates azimuth and elevation angle for 169 beamforming vectors used in simulations;

FIG. 14 illustrates an example of meshing used by a method of moments (MoM) solver;

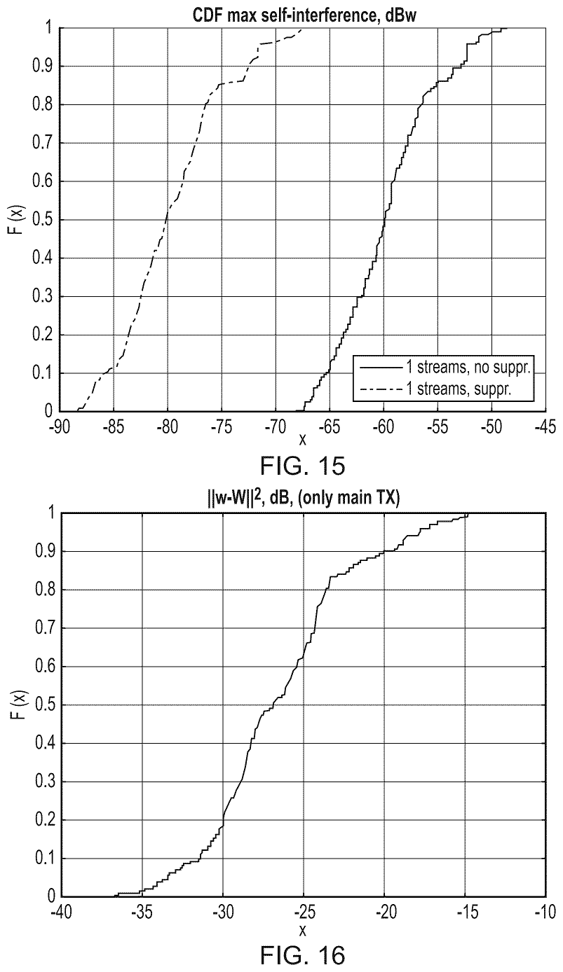

FIG. 15 shows an empirical CDF of the interference power at the most affected antenna element for antenna configuration 1 and the reference antenna configuration for different beamforming vectors;

FIG. 16 shows an empirical CDF of the distortion of different beamforming vectors for antenna configuration 1;

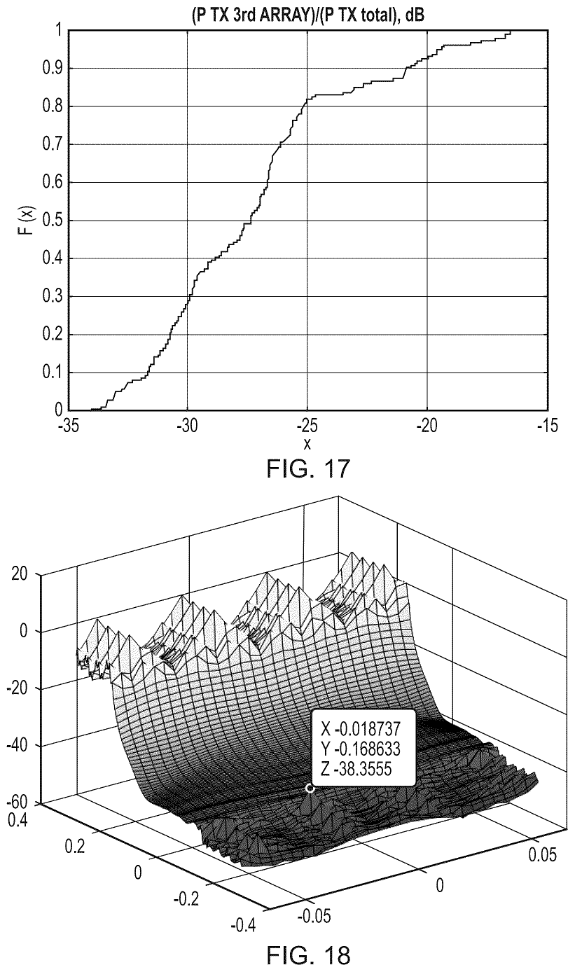

FIG. 17 shows an empirical CDF of relative power of the suppressing array for different beamforming vectors for antenna configuration 1;

FIG. 18 shows norm of the Poynting vector, suppressing array off, for antenna configuration 1;

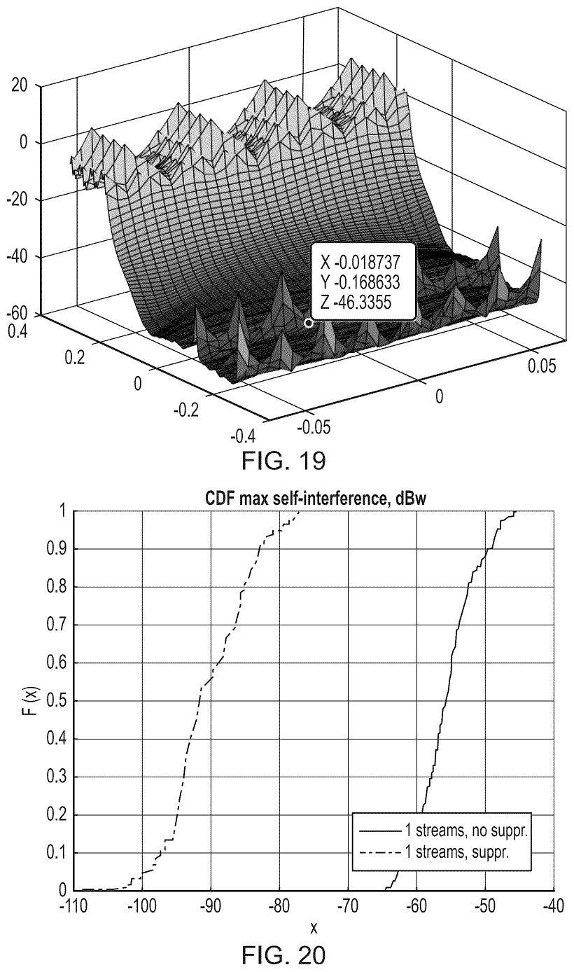

FIG. 19 shows norm of the Poynting vector, suppressing array on, for antenna configuration 1;

FIG. 20 shows an empirical CDF of the interference power at the most affected antenna element for antenna configuration 2 and the reference antenna configuration for different beamforming vectors;

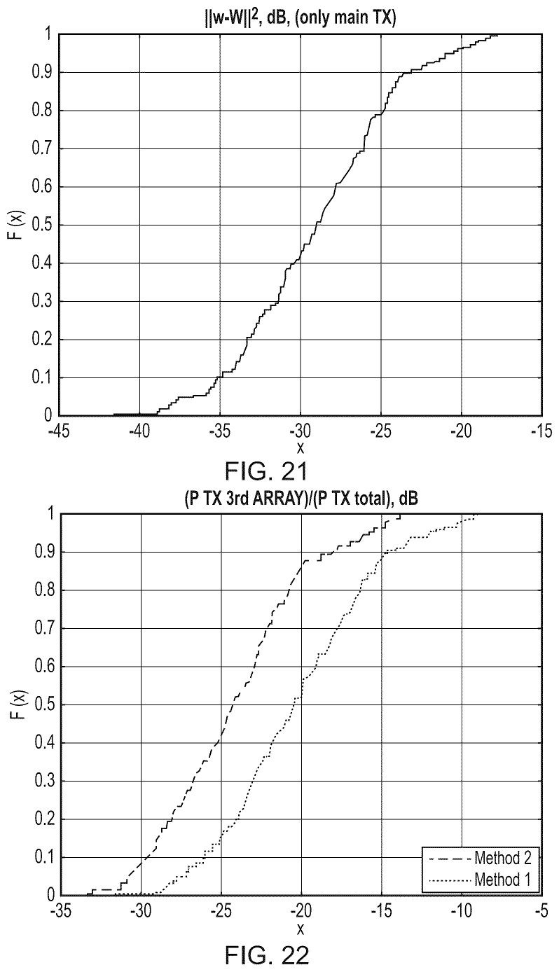

FIG. 21 shows an empirical CDF of the distortion of different beamforming vectors for antenna configuration 2;

FIG. 22 shows an empirical CDF of relative power of the suppressing array for different beamforming vectors for antenna configuration 2;

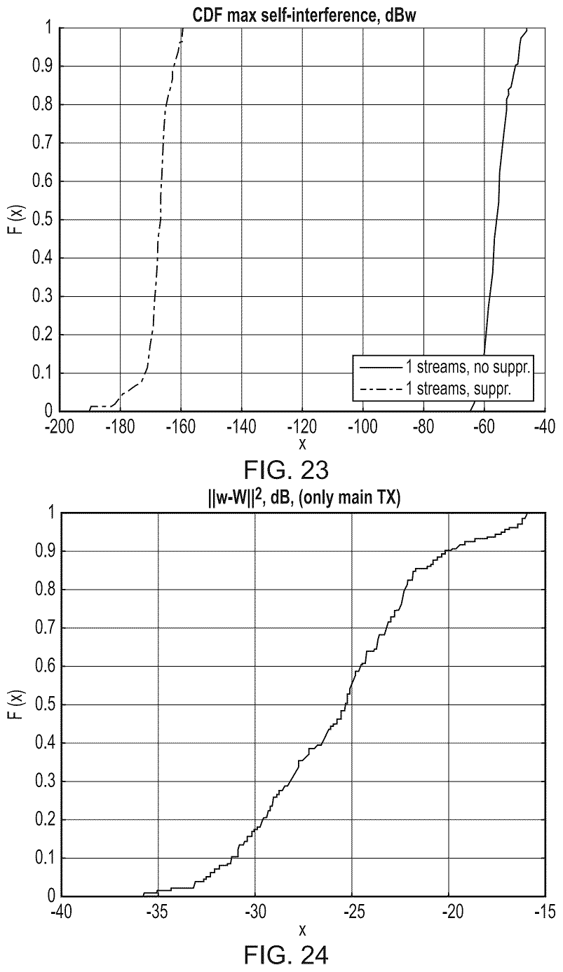

FIG. 23 shows an empirical CDF of the interference power at the most affected antenna element for antenna configuration 3 and reference antenna configuration for different beamforming vectors;

FIG. 24 shows an empirical CDF of the distortion of different beamforming vectors for antenna configuration 3;

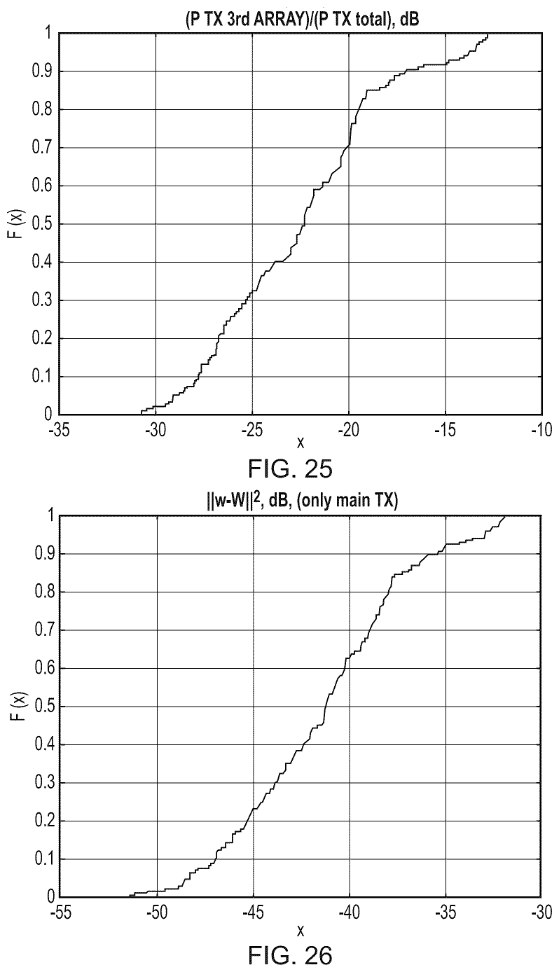

FIG. 25 shows an empirical CDF of relative power of the suppressing array for different beamforming vectors for antenna configuration 3;

FIG. 26 shows an empirical CDF of the distortion of different beamforming vectors for antenna configuration 3 with an additional 10 dB isolation;

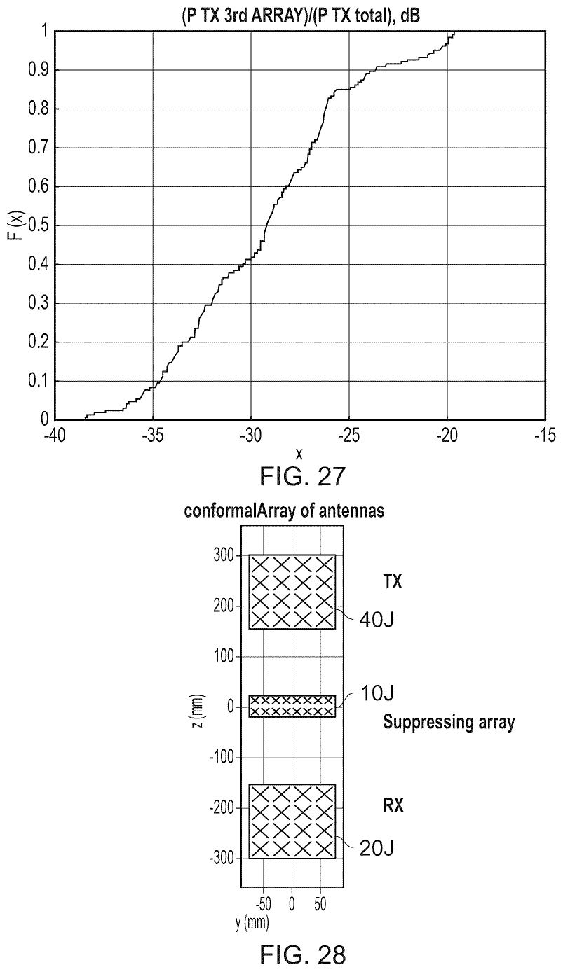

FIG. 27 shows an empirical CDF of relative power of the suppressing array for different beamforming vectors for antenna configuration 3 with an additional 10 dB isolation

FIG. 28 illustrates antenna configuration 4 according to one example embodiment;

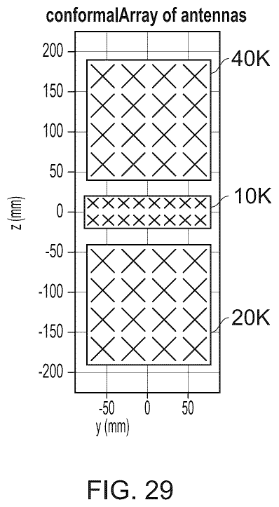

FIG. 29 illustrates antenna configuration 5 according to one example embodiment;

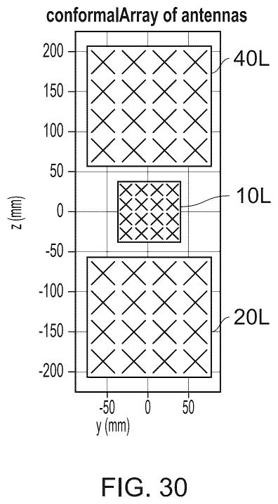

FIG. 30 illustrates antenna configuration 6 according to one example embodiment;

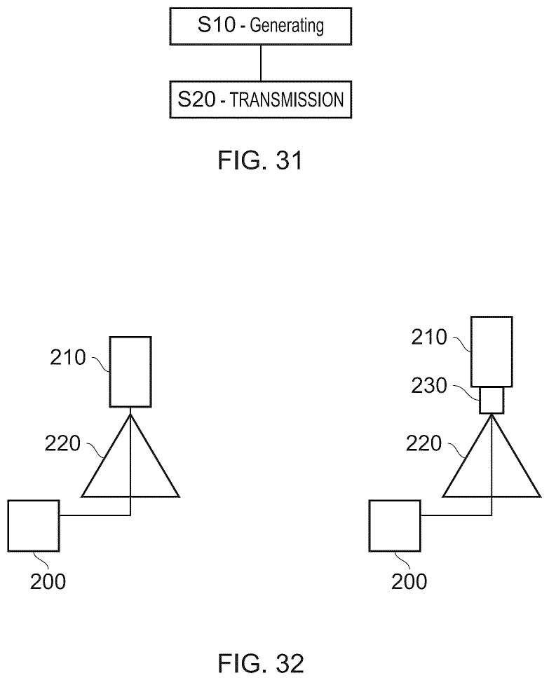

FIG. 31 is a flowchart illustrating a method according to one example embodiment; and

FIG. 32 illustrates example arrangements of the antenna configurations.

### DETAILED DESCRIPTION

Before discussing the example embodiments in any more detail, first an overview will be provided. Some example embodiments provide an apparatus comprising a suppression antenna array which generates a compensating, counteracting or offsetting electromagnetic field which reduces or nullifies interference or signal power of transmissions from a transmit antenna array received by a receive antenna array. The suppression antenna array typically comprises a number of suppression antenna array elements which may be located at a variety of different locations suitable to provide the compensating electromagnetic field which reduces or nullifies interference or signal power of transmissions from the transmit antenna array received by the receive antenna array. Typically, those suppression antenna array elements may be located a distance away from transmission antenna array elements. For example, the suppression antenna array elements may be located between the transmit antenna array and the receive antenna array. Likewise, the suppression antenna array elements may be located proximate, adjacent or co-located with the receive antenna array elements. Typically, the suppression antenna array generates it offsetting electromagnetic field which reduces or nullifies interference or signal power of transmissions from the transmit antenna array received by the receive antenna array in a near field region and which does not (fails to) radiate efficiently or effectively in the far field region. Typically, the modulated data symbols used to generate signals for transmission by the transmit antenna array are used to generate signals supplied to the suppression antenna array when generating the compensating electromagnetic field. Those signals are typically generated by applying a weight vector to the modulated data symbols used to generate signals for transmission by the transmit antenna array. The weight vector may be determined in a variety of different ways. The suppression antenna array may be positioned in a variety of different locations and other passive techniques may be employed to improve the reduction of interference. The apparatus may be provided as part of a network node device such as, for example, an infrastructure device, a base station, a remote radio head (RRH), an infrastructure node, a router, a user equipment and the like.

### Subband Non-Overlapping Full Duplex (SBFD)

SBFD is a duplexing scheme which is based on Time Division Duplexing (TDD). In regular TDD, during a time slot (or part of the slot), transmission is allowed only in the downlink (DL) or the uplink (UL) direction. In SBFD, during a time slot, transmission is allowed in both directions, typically using different frequency sub-bands or subchannels. Like TDD, SBFD uses one frequency channel. UL and DL transmission occurs on two or more temporarily or permanently allocated frequency subchannels. For example, a DL slot may use all frequency sub-bands or subchannels, an SBFD slot may use multiple frequency sub-bands or subchannels for DL and the remainder for UL (together with guard bands) and an UL slot may use all frequency sub-bands or subchannels. The main motivation for SBFD is to improve coverage and to reduce latency. The coverage improvement is expected because a user equipment (UE) has more uplink transmission opportunities (in terms of time) and therefore can use more energy for uplink transmission. Latency improvement is expected because UL transmission opportunities occur more frequently.

Base station (gNB) self-interference is a factor for SBFD, creating challenges for SBFD implementation. To make UL reception possible, the gNB receiver should be protected (isolated) from the gNB's own transmission in DL.

Beam nulling is used to increase DL-UL isolation in SBFD. It can provide up to 20 dB of additional isolation in expense of 1 dB equivalent isotropic radiated power (EIRP) loss. For example, an antenna configuration can have 32 cross-polarized antenna elements at a transmission (TX) antenna array and with the same number of antenna elements at a reception (RX) antenna array and 4λ spacing between TX and RX arrays. The beam nulling method provides around 18 dB of additional isolation for this antenna configuration as shown in FIG. 1.

However, this method may not be suitable for multi-stream DL transmission. The problem is that multi-stream transmission relies on the orthogonality of the beamforming vectors, applied to the different streams. Beam nulling methods transform initially orthogonal beamforming vectors to form nulls at the RX antenna array elements. New beamforming vectors, obtained by this transformation, lose orthogonality. From squared L2 norm of the difference between the original and the transformed beamforming vectors it can be seen in FIG. 2 that in the worst case this norm is around-7 dB and is less than −16 dB for 50% of the vectors. This may be not good enough for maintaining sufficient orthogonality for multi-stream transmission. Besides, beam nulling alone can't provide the total required isolation, which is within a range of 85-100 dB. It can play the role as an additional means, providing at most 20 dB of isolation (considering the case when the number of RX and TX antenna array elements are equal).

### Self-Interference Suppression

Some example embodiments provide a technique of self-interference suppression which provides much higher isolation capability than beam nulling and doesn't have the previously-mentioned orthogonality drawbacks. In particular, some example embodiments provide a technique for self-interference suppression for SBFD. In some example embodiments, an antenna array is provided where the TX and RX antenna arrays are provided typically in a conventional SBFD antenna configuration and a low power TX antenna array is provided, which is dedicated to suppressing self-interference. The purpose of the suppressing array is to generate an electromagnetic field which, being superimposed with the electromagnetic field generated by the TX antenna array, provides nulls at the RX antenna array elements. In other words, the suppressing antenna array suppresses self-interference by generating a “compensating” electromagnetic field. The two electromagnetic signals received by the RX antenna array resulting from the “compensating” electromagnetic field and the electromagnetic field generated by the TX antenna array combine to provide nulls and reduce self-interference. The suppressing array can be implemented in many ways as set out below.

### Example Antenna Configurations

FIG. 3 shows an implementation where the suppressing array is divided into two sub-arrays 10A1, 10A2. One sub-array is located at the upper and another at the lower edge of the RX antenna array 20A. FIG. 4 shows an implementation where antenna elements of the suppressing antenna array 10B are interlaced with the antenna array elements of the RX antenna array 20B. FIG. 5 shows an implementation where antenna elements of the suppressing array 10C are located in front of the antenna elements of the RX antenna array 20C. FIG. 6 shows a passive suppressing antenna array 30D located between the TX antenna array 40D and the RX antenna array 20D. The passive suppressing antenna array can be implemented in a form of, for example, wave trap or shield. It allows a reduction in required radiation power of the suppressing array and distortion of the original DL beamforming vector. FIG. 7 shows an implementation where the low power suppressing antenna array 10E is located between the TX antenna array 40E and RX antenna array 20E. The dimensions of the suppressing antenna array elements, the distance between elements and the overall dimensions of the array can be reduced comparatively to the corresponding dimensions of the TX array because the suppressing antenna array 10E is operating in the near field. The form factor of the suppressing array can vary from one implementation to another. FIG. 8 shows an implementation where the low power suppressing antenna array 10F with a different form factor is located between the TX antenna array 40F and RX antenna array 20F. FIG. 9 shows an implementation where the suppressing antenna elements of the suppressing antenna array 10G are located on the structure providing the main TX antenna array 40G. Similarly, and not illustrated in FIG. 9, the suppressing TX elements can be located on the structure providing the main RX antenna array 20G. The suppressing antenna array can have fewer antenna elements than the main TX/RX antenna array if one radio frequency (RF) chain at the receiver side is connected to 2 or more RX antenna elements. For example, FIG. 10 shows an antenna configuration where one RF chain is connected to 4 RX antenna elements. In other words, the main RX (and TX) antenna array has 4 sub-arrays. In this case, a smaller suppressing antenna array consisting of only 4 antenna elements is sufficient for self-interference suppression. FIG. 11 shows an implementation where a wave trap 30I is located between the TX antenna array 401 and the suppressing antenna array 10I. This wave trap allows a reduction in required radiation power of the suppressing array and distortion of the original DL beamforming vector. The suppressing antenna arrays set out above can be combined with other isolation methods. Although the example embodiments mentioned above provide for the suppressing antenna elements located on the structure of the antenna array, it will be appreciated that in other example embodiments, the suppressing antenna elements may be located on a separate structure adjacent or near the TX and/or RX antenna elements. That separate structure many be attached to or placed near the and/or RX antenna elements.

### Suppressing Antenna Array—Signal Generation

The suppressing antenna array is connected to the analog and digital chain, similar to that of the main TX antenna array. To generate a compensating EM-field it transmits the same data but applies special beamforming or weight vectors.

Two methods of calculating the compensating beamforming or weight vectors are provided. Method 1 may provide higher self-interference suppression, but it is applicable to a more limited set of the antenna configurations. Method 2 provides lower self-interference suppression, but it is applicable to a broader set of antenna configurations and requires less power for the suppressing array.

FIG. 12 shows schematically one example embodiment including three antenna arrays: the TX array, the RX array and the suppressing TX array. The TX array and the suppressing TX array are connected to similar but separate analog RF blocks, which comprises a digital-to-analog converter (DAC), an RF filter (≈), a mixer (⊗), a local oscillator (LO), and a power amplifier (PA). Each analog RF block is connected to a digital frontend block, which comprises an inverse fast Fourier transform (iFFT), a cyclic prefix addition block (CP), a digital upconverter (DUC), a crest factor reduction block (CFR) and a digital predistortion block (DPD). In some implementations the DPD can be omitted from a suppressing digital frontend due to the low power radiated by the suppressing TX array.

Each baseband processing block has one additional functional block due to legacy implementation: beamforming vector for a single stream (or a beamforming matrix for multi-stream (such as single-user multiple input, multiple output (SU-MIMO) or multi-user multiple input, multiple output (MU-MIMO)) transformation block, denoted as w→W and w→Wₛ. Beamforming vector transformation blocks calculate beamforming or weight vectors W and Wₛ using Method 1 or Method 2, described below. Method 1 does not change w: W=w and therefore, if this method is used, w→W block can be omitted. The output of the beamforming vector transformation block is connected to the input of the beamforming block (BF), which is no different from the legacy implementation. Another input of BF block is a modulated data symbol s (s is scalar for a single stream and it is a data symbol vector for a multi-stream). It is the same in the TX chain and the suppressing TX chains. The rest of the blocks in the TX and suppressing TX baseband processing are no different from the legacy implementation and are not shown in FIG. 12.

It is assumed that the beamforming vector applied to the TX array changes as little as possible, or does not change it at all and that self-interference suppression is done by applying appropriate beamforming or weight vector to the suppressing array. Also, for ease of understanding, both methods are presented in their simplest form, ignoring noise.

Method 1 calculates the beamforming vector applied to the suppressing array without any modification of the beamforming vector applied to the TX array. Method 2 calculates the beamforming vector applied to the suppressing array and slightly modifies the beamforming vector applied to the TX array.

### Method 1

Method 1 calculates beamforming weights for the suppressing array according to equation (1):

$${W}_{S} = {C}_{S}^{- 1} {w}^{T} C \qquad ( 1 )$$

W_{S}∈ [symbol] is the beamforming vector applied to the suppressing array.
N_{S} is the number of antenna array elements of the suppressing array.
C_{S}∈ [symbol] is a covariance matrix of the channel between the suppressing array and the RX array.
w∈ [symbol] is the beamforming vector applied to the TX array.
N_{TX} is the number of antenna array elements of the TX array.

The covariance matrix C_{S} is given by equation (2):

$${C}_{S} = {{H}_{S} ( {H}_{S} )}^{H} \qquad ( 2 )$$

( . . . )^{H} denotes Hermitian transpose.
H_{S}∈ [symbol] is the channel matrix of the channel between the suppressing array and the RX array:

$${H}_{S} = [ \begin{matrix}{h}_{1 , 1}^{S} & ⋯ & {h}_{1 , {N}_{RX}}^{S} \\ ⋯ & ⋱ & ⋯ \\ {h}_{{N}_{s} , 1}^{S} & ⋯ & {h}_{{N}_{s} , {N}_{RX}}^{S}\end{matrix} ] \qquad ( 3 )$$

$${h}_{l , m}^{S} ∈ {ℂ}^{1 \times 1}$$

is the channel between the I-th antenna array element of the suppressing array and the m-th array antenna element of the RX array.
N_{RX} is the number of antenna array elements of the RX array.

The covariance matrix C is given by equation (4):

$$C = {H ( H )}^{H} \qquad ( 4 )$$

( . . . )^{H} denotes Hermitian transpose.
H∈ [symbol] is the channel matrix representing self-interference channel between the TX and the RX antenna arrays.

The matrix H is given by equation (5):

$$H = [ \begin{matrix}{h}_{1 , 1} & ⋯ & {h}_{1 , {N}_{RX}} \\ ⋯ & ⋱ & ⋯ \\ {h}_{{N}_{TX} , 1} & ⋯ & {h}_{{N}_{TX} , {N}_{RX}}\end{matrix} ] \qquad ( 5 )$$

h_{l,m}∈ [symbol] is the channel between the I-th antenna array element of the TX array and the m-th array antenna element of the RX array.

In another implementation the covariance matrices in equation (1) can be replaced by the channel matrices, see equation (6):

$${W}_{S} = {H}_{S}^{- 1} {w}^{T} H \qquad ( 6 )$$

### Method 2

Method 2 calculates the beamforming vector according to equation (7).

$${W}_{C} = {( 1 - {C}_{c} )}^{M} {w}_{C} \qquad ( 7 )$$

∈ [symbol] is a concatenation of two beamforming vectors: w and w_{S}:

$${w}_{C} = [ \begin{matrix}w \\ {w}_{S}\end{matrix} ] \qquad ( 8 )$$

w is a beamforming vector applied to the TX array and defined above, and w_{S} is a beamforming vector applied to the suppressing array. w_{S} can be initialized by a zero vector: w_{S}=0, or using equation (1).
W_{C} is a vector, obtained after transformation of w_{c}:

$${W}_{C} = [ \begin{matrix}W \\ {W}_{S}\end{matrix} ] \qquad ( 9 )$$

W_{S} is a transformed beamforming vector applied to the suppressing array.
W∈ [symbol] is a transformed beamforming vector applied to the TX array.

$$M ∈ {N}_{1}^{1 \times 1}$$

is a power of the matrix polynomial and is a design parameter.

The covariance matrix C_{S}∈ [symbol] is given by equation (10):

$${C}_{C} = {{H}_{C} ( {H}_{C} )}^{H} \qquad ( 10 )$$

H_{C}∈ [symbol] is a concatenation of two matrices: H and H_{S}:

$${H}_{C} = [ \begin{matrix}H \\ {H}_{S}\end{matrix} ] \qquad ( 11 )$$

### Simulation Results

To evaluate the performance of the methods, the interference gain vectors I∈ [symbol] (equation (12)) and Iₛᵤₚ∈ [symbol] (equation (13)) were calculated. Each element of this vector is an interference gain value at one antenna array element of the RX array.

$$I = {( {H}_{C} )}^{T} {w}_{C} \qquad ( 12 )$$

$${I}_{sup} = {( {H}_{C} )}^{T} {W}_{C} \qquad ( 13 )$$

The performance of the methods was assessed using the interference gain power at the most affected antenna array element, calculated using equations (14) and (15).

$${I}^{m ax} = max {\vert I \vert}^{2} \qquad ( 14 )$$

$${I}_{sup}^{m ax} = max {\vert {I}_{sup} \vert}^{2} \qquad ( 15 )$$

Another criterium for performance evaluation is a squared L2 norm of the difference of the beamforming vectors before and after transformation. Naturally, this norm is desired to be as small as possible. For legacy beam nulling, this norm is calculated according to equation (16) and for Method 1 and 2 according to equation (17).

$${‖ w - W ‖}^{2} \qquad ( 16 )$$

$${‖ {w}_{C} - {W}_{C} ‖}^{2} \qquad ( 17 )$$

w_{C} is defined according to equation (8). In equation (17), w_{S} in w_{C} is a zero vector, that is, a comparison is made with the case when the suppressing array is powered down. Another criterion for evaluating the proposed methods is the power ratio radiating by the suppressing array to the overall TX power. This ratio can be calculated according to equation (18).

$${‖ {W}_{S} ‖}^{2} / {‖ {W}_{C} ‖}^{2} \qquad ( 18 )$$

The interference power at the most affected antenna array element, the distortion of the transformed beamforming vector and the power ratio radiating by the suppressing array to the overall TX power depend on the beamforming vector w applied to the main TX antenna array. To take this into account simulations were done for 169 beamforming vectors providing different beam directions. FIG. 13 shows the azimuth and elevation angle corresponding to each beamforming vector in the set.

An antenna configuration with 16 cross-polarized antenna elements at the TX array and with the same number of antenna elements at the RX array were used in simulations. Each antenna array element is simulated as two orthogonal dipoles having a length 0.5λ, where λ is a wavelength. The distance between antenna array elements is 0.5λ in the horizontal and the vertical direction. The distance between TX and RX antenna arrays is equal to 4λ. Simulations were done with an Electro-Magnetic (EM)-simulator, using a method of moments (MoM) solver. An example of meshing, used by the MoM solver is shown on FIG. 14.

### Antenna Configuration 1 (FIG. 3)

In antenna configuration 1, shown in FIG. 3, the suppressing array is divided into two sub-arrays. One sub-array 10A1 is located at the upper and another 10A2 at the lower edge of the RX antenna array 20A. Each sub-array has 8 cross-polarized antenna elements. The length of each dipole, as well as the horizontal spacing between the elements, is half that of the RX antenna array 20A and is equal to 0.25λ.

FIG. 15 shows an empirical cumulative distribution function (CDF) of the interference power at the most affected antenna array element for two cases: suppression array is off (“no suppression” curve) and suppression array is on (“suppr.” curve). Achieved suppression is about the same as for “traditional” beam nulling (see FIG. 1). However, distortion of the original beamforming vector w is around 10 dB smaller than for “traditional” beam nulling (compare FIG. 16 and FIG. 2). The power of the suppressing array is in the worst case −17 dB of the total power despite the suboptimal dimensions of that antenna array (see FIG. 17). FIG. 18 and FIG. 19 show the EM-field with the suppressing array off and on for antenna configuration 1. The horizontal axis on those FIGS. correspond to z and y axis on FIG. 3. The vertical axis shows the norm of the Poynting vector of the EM-field. FIG. 19 clearly shows peaks, created by the suppressing array, which are absent on FIG. 18 and suppression of the small peaks, visible on FIG. 16, and corresponding to the RX antenna array elements. Large upper peaks on both FIGS. are created by the main TX antenna array.

### Antenna Configuration 2 (FIG. 4)

In antenna configuration 2, shown in FIG. 4, antenna elements of the suppressing antenna array 10B are interlaced with the antenna array elements of the RX antenna array 20B. The length of each dipole of the antenna element of the suppressing antenna 10B array is equal to 0.25λ, however the horizontal and vertical spacing between the elements, is 0.5λ. The interference power at the most affected antenna element for antenna configuration 2 is shown in FIG. 20. FIG. 20 shows two empirical CDF curves: one for Method 2 and another for no suppression case. The curves show that Method 2 provides more than 30 dB of additional isolation. The interference power for Method 1 is not shown on FIG. 20 because this method completely nullifies self-interference in the idealistic simulations, which do not take into account non-idealities of the self-interference channel matrix estimation, TX noise, etc. FIG. 21 shows the empirical CDF of the distortion of beamforming vectors for Method 2. FIG. 21 shows that in the worst case this distortion is less than −17 dB. The distortion of the beamforming vectors is zero for Method 1 and it is not shown on FIG. 21. FIG. 22 shows the empirical CDF of relative power of the suppressing array for different beamforming vectors. One curve is for Method 1 and another for Method 2. The power of the suppressing array is in the worst case −9 dB of the total power for Method 1 and −14 dB for Method 2.

### Antenna Configuration 3 (FIG. 5)

FIG. 5 shows antenna configuration 3. Antenna elements of the suppressing antenna array 10C are allocated in front of the antenna elements of the RX antenna array 20C. The size of each dipole of the suppressing antenna array is 0.25λ. This antenna configuration almost completely nullifies self-interference even with Method 2, see FIG. 23. Distortion of the beamforming vectors is less than −15 dB (see FIG. 24) and the power of the suppressing array is less than −13 dB of the total power (see FIG. 25).

Antenna Configuration 3 with Additional Isolation

Providing additional isolation by introducing, for example, a passive antenna array 30D between the TX antenna array 40D and the RX antenna array 20D is beneficial, as shown in FIG. 6. Antenna configuration 3 was simulated with an assumption that an additional isolation of 10 dB is provided by the passive antenna array. With this assumption the distortion of the beamforming vectors is reduced by ˜15 dB (FIG. 26) and the power of the suppressing array by ˜7 dB (FIG. 27).

### Antenna Configuration 4 (FIG. 28)

FIG. 28 shows an antenna configuration with 32 cross-polarized antenna array elements at the TX antenna array 40J and with the same number of antenna array elements at the RX antenna array 20J and 4λ spacing between TX and RX antenna arrays. The suppressing antenna array 10J is located between the TX and the RX antenna arrays 40J, 20J. It also has 32 cross-polarized antenna array elements. The length of each dipole, as well as the horizontal and vertical spacing between the elements, is half that of the main antenna array and is 0.25λ, where λ is a wavelength.

### Antenna Configuration 5 (FIG. 29)

FIG. 29 shows antenna configuration 5. It is similar to antenna configuration 4, but the spacing between the TX and the RX antenna arrays 40K, 20K is reduced to 1.0λ.

### Antenna Configuration 6 (FIG. 30)

FIG. 30 shows antenna configuration 6. Unlike antenna configurations 4 and 5 the suppression antenna array 10L has 4 rows and 4 columns of antenna elements. Spacing between the TX and RX antenna array 40L, 20L is equal to 1.5λ.

### Efficiency

To reduce dimensions and weight of the antenna array, antenna elements of the suppressing antenna array may be reduced in size comparatively to the optimal size. This causes a loss of efficiency of the suppressing antenna elements. For example, for the dipole, which size is reduced to 0.25) this loss can be around 10-11.6 dB. However, this is may not be a problem because the radiated power of the suppressing array is from 1% to 10% of the total radiated power for the worst case beam direction, depending on the antenna configuration (see FIG. 17, FIG. 22, FIG. 25, FIG. 27). Therefore, the power, required by TX suppressing RF PA, is roughly 5-50% of the total power (main TX RF PA power+suppressing TX RX PA power).

FIG. 31 illustrates a method according to one example embodiment. At step S10, the suppression signals and the transmit antenna array signals are generated as set out above. At step S20, the transmit antenna array signals are provided to the transmit antenna array which generates a transmission electromagnetic field and the suppression signals are provided to the suppression antenna array which generates a compensating electromagnetic field which reduces interference from said transmission electromagnetic field received by a receive antenna array.

FIG. 32 shows example deployments of the antenna configurations described above. In one example embodiment, a base station, such as a gNB 200 generates signals for the antenna array 210 which is deployed on a tower 220. In one example embodiment, the gNB 200 is coupled with the antenna array 210 via a remote radio head 230.

Some example embodiments provide for high suppression capability, low distortion of the beamforming vector (suitable for MU-MIMO) and are easier to implement than an analog RF suppression method but requires additional hardware.

A person of skill in the art would readily recognize that steps of various above-described methods can be performed by programmed computers. Herein, some embodiments are also intended to cover program storage devices, e.g., digital data storage media, which are machine or computer readable and encode machine-executable or computer-executable programs of instructions, wherein said instructions perform some or all of the steps of said above-described methods. The program storage devices may be, e.g., digital memories, magnetic storage media such as a magnetic disks and magnetic tapes, hard drives, or optically readable digital data storage media. The embodiments are also intended to cover computers programmed to perform said steps of the above-described methods. The term non-transitory as used herein, is a limitation of the medium itself (i.e., tangible, not a signal) as opposed to a limitation on data storage persistency (e.g. RAM vs ROM).

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

The ordering of method steps set out above may not be critical or fixed and the exact ordering of the steps may be varied as appropriate.

Although example embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

Further aspects and example embodiments will now be described.

An apparatus, comprising: a transmit antenna array comprising a plurality of transmit antenna array elements; a receive antenna array comprising a plurality of receive antenna array elements; a suppression antenna array comprising a plurality of suppression antenna array elements; and a signal generator configured to generate suppression antenna array element drive signals for the suppression antenna array elements to generate a compensating electromagnetic field to reduce interference received by the plurality of receive antenna array elements from the plurality of transmit antenna array elements.

The signal generator may be configured to generate the suppression antenna array element drive signals to reduce interference in a near field region.

The signal generator may be configured to generate transmit antenna array element drive signals provided to the plurality of transmit antenna array elements and to generate the suppression antenna array element drive signals from the modulated data signals used to generate the transmit antenna array element drive signals.

The signal generator may be configured to generate the suppression antenna array element drive signals by applying a suppression weight vector to the modulated data signals used to generate the transmit antenna array element drive signals.

The signal generator may be configured to one of apply and not apply a modification to a weight vector to the modulated data signals used to generate the transmit antenna array element drive signals.

The signal generator may be configured to generate the suppression antenna array element drive signals based on a matrix of an interference channel between the suppression antenna array and the receive antenna array and to calculate the weight vector which, when applied to the suppression antenna array, causes the compensating electromagnetic field, when superimposed with an electromagnetic field generated by the transmit antenna array, reduces self-interference at the receive antenna array elements.

The signal generator may be configured to generate the suppression antenna array element drive signals based on a covariance matrix of an interference channel between the transmit antenna array and the receive antenna array and to calculate the weight vector which, when applied to the suppression antenna array, causes the compensating electromagnetic field, when superimposed with an electromagnetic field generated by the transmit antenna array, reduces self-interference at the receive antenna array elements.

The signal generator may be configured to generate the suppression antenna array element drive signals based on a matrix of an interference channel between the suppression antenna array and the receive antenna array and a matrix of an interference channel between the transmit antenna array and the receive antenna array and to calculate the weight vector which, when applied to the suppression antenna array, causes the compensating electromagnetic field, when superimposed with an electromagnetic field generated by the transmit antenna array, reduces self-interference at the receive antenna array elements.

The signal generator may be configured to generate the suppression antenna array element drive signals based on a covariance matrix calculated from measurements of an interference channel between the suppression antenna array and the receive antenna array and on a covariance matrix calculated from measurements of an interference channel between the transmit antenna array and the receive antenna array and to calculate the weight vector which, when applied to the suppression antenna array, causes the compensating electromagnetic field, when superimposed with an electromagnetic field generated by the transmit antenna array, reduces self-interference at the receive antenna array elements.

The signal generator may be configured to generate the suppression antenna array element drive signals based on a covariance matrix calculated from a matrix of an interference channel between the suppression antenna array and the receive antenna array and on a covariance matrix calculated from a matrix of an interference channel between the transmit antenna array and the receive antenna array and to calculate the weight vector which, when applied to the suppression antenna array, causes the compensating electromagnetic field, when superimposed with an electromagnetic field generated by the transmit antenna array, reduces self-interference at the receive antenna array elements.

The signal generator may be configured to generate the suppression antenna array element drive signals based on a matrix of a channel between the suppression antenna array and the receive antenna array and between the transmit antenna array and the receive antenna array and to calculate the weight vector which, when applied partially to the suppression antenna array and partially to the transmit antenna array, causes the suppression antenna array to generate the compensating electromagnetic field and the transmit antenna array to generate a transmit electromagnetic field which, when superimposed, reduces self-interference at the receive antenna array elements.

The signal generator may be configured to generate the suppression antenna array element drive signals based on a covariance matrix calculated from measurements of a channel between the suppression antenna array and the receive antenna array and between the transmit antenna array and the receive antenna array and to calculate the weight vector which, when applied partially to the suppression antenna array and partially to the transmit antenna array, causes the suppression antenna array to generate the compensating electromagnetic field and the transmit antenna array to generate a transmit electromagnetic field which, when superimposed, reduces self-interference at the receive antenna array elements.

The signal generator may be configured to generate the suppression antenna array element drive signals based on a covariance matrix calculated from a matrix of a channel between the suppression antenna array and the receive antenna array and between the transmit antenna array and the receive antenna array and to calculate the weight vector which, when applied partially to the suppression antenna array and partially to the transmit antenna array, causes the suppression antenna array to generate the compensating electromagnetic field and the transmit antenna array to generate a transmit electromagnetic field which, when superimposed, reduces self-interference at the receive antenna array elements.

The suppression antenna array element drive signals may have a lower power than signals provided to the plurality of transmit antenna array elements.

The suppression antenna array elements may be located at a distance away from transmission antenna array elements.

The suppression antenna array elements may be located between the transmit antenna array and the receive antenna array.

The suppression antenna array elements may be located proximate, adjacent the receive antenna array elements.

The suppression antenna array elements may be co-located with the receive antenna array elements.

The suppression antenna array elements may be located on the receive antenna array.

The suppression antenna array elements may be located on opposing edges of the receive antenna array.

The suppression antenna array elements may be co-located with the receive antenna array elements.

The suppression antenna array elements may be positioned with the receive antenna array elements.

The suppression antenna array elements may be interposed between the receive antenna array elements.

The suppression antenna array elements may be located on the transmit antenna array.

The suppression antenna array elements may be located an edge of the transmit antenna array closest the receive antenna array.

The suppression antenna array elements may be located away from the transmit antenna array and the receive antenna array.

The suppression antenna array elements may be located in a space between the transmit antenna array and the receive antenna array.

The space between the transmit antenna array and the receive antenna array may be dimensioned to be up to 4) of a transmission frequency of signals from the plurality of transmit antenna array elements.

The space between the transmit antenna array and the receive antenna array may be dimensioned to be up to 1.5λ of a transmission frequency of signals from the plurality of transmit antenna array elements.

The plurality of suppression antenna array elements is no smaller than the plurality of receive antenna array elements.

The plurality of transmit antenna array elements and the plurality of suppression antenna array elements may be a matching number.

Receive antenna array elements of a subarray of the receive antenna array and the plurality of suppression antenna array elements may be a matching number

The plurality of receive antenna array elements may be arranged in an array of a number of rows and columns and the plurality of suppression antenna array elements may be arranged in in a matching number of rows and columns.

The plurality of receive antenna array elements may be arranged in an array of a number of rows and a number of columns and the plurality of suppression antenna array elements may be arranged in different numbers of rows and columns.

The plurality of receive antenna array elements may be arranged in an array of a number of rows and a number of columns and the plurality of suppression antenna array elements may be arranged in a decreased number of rows and an increased number of columns.

The plurality of receive antenna array elements may be arranged a distance apart and the plurality of suppression antenna array elements may be arranged a different distance apart.

The plurality of receive antenna array elements may be arranged a distance apart and the plurality of suppression antenna array elements may be arranged a smaller distance apart.

The plurality of receive antenna array elements may be arranged a distance apart and the plurality of suppression antenna array elements may be arranged at least a half of the distance apart.

The plurality of transmit antenna array elements and the plurality of receive antenna array elements may be a matching number.

The apparatus may comprise a passive suppression array configured to suppress signals received by the plurality of receive antenna array elements from the plurality of transmit antenna array elements.

The apparatus may comprise at least one of the following: a wave trap; or electromagnetic shield configured to suppress signals received by the plurality of receive antenna array elements from the plurality of transmit antenna array elements.

The apparatus may comprise a sub-band, non-overlapping, full-duplex antenna assembly.

The apparatus may comprise a network node device comprising circuitry configured to generate radio frequency signals.

The apparatus may comprise one of an infrastructure device, a base station, a remote radio head (RRH), an infrastructure node, a router, a user equipment comprising circuitry configured to generate radio frequency signals.

A method, comprising: generating suppression antenna array element drive signals for a plurality of suppression antenna array elements of a suppression antenna array of an apparatus comprising a transmit antenna array comprising a plurality of transmit antenna array elements, a receive antenna array comprising a plurality of receive antenna array elements and the plurality of suppression antenna array elements to generate a compensating electromagnetic field to reduce interference received by the plurality of receive antenna array elements from the plurality of transmit antenna array elements.

The generating suppression antenna array element drive signals may comprise generating the suppression antenna array element drive signals to reduce interference in a near field region.

The method may comprise generating transmit antenna array element drive signals provided to the plurality of transmit antenna array elements and the generating suppression antenna array element drive signals may comprise generating the suppression antenna array element drive signals from modulated data signals used to generate the transmit antenna array element drive signals.

The generating suppression antenna array element drive signals may comprise generating the suppression antenna array element drive signals by applying a suppression weight vector to the modulated data signals used to generate the transmit antenna array element drive signals.

The generating suppression antenna array element drive signals may comprise one of applying and not applying a modification to a weight vector to the modulated data signals used to generate the transmit antenna array element drive signals.

The generating suppression antenna array element drive signals may comprise generating the suppression antenna array element drive signals based on a matrix of an interference channel between the suppression antenna array and the receive antenna array and calculating the weight vector which, when applied to the suppression antenna array, causes the compensating electromagnetic field, when superimposed with an electromagnetic field generated by the transmit antenna array, reduces self-interference at the receive antenna array elements.

The generating suppression antenna array element drive signals may comprise generating the suppression antenna array element drive signals based on a covariance matrix of an interference channel between the transmit antenna array and the receive antenna array and calculating the weight vector which, when applied to the suppression antenna array, causes the compensating electromagnetic field, when superimposed with an electromagnetic field generated by the transmit antenna array, reduces self-interference at the receive antenna array elements.

The generating suppression antenna array element drive signals may comprise generating the suppression antenna array element drive signals based on a matrix of an interference channel between the suppression antenna array and the receive antenna array and a matrix of an interference channel between the transmit antenna array and the receive antenna array and calculating the weight vector which, when applied to the suppression antenna array, causes the compensating electromagnetic field, when superimposed with an electromagnetic field generated by the transmit antenna array, reduces self-interference at the receive antenna array elements.

The generating suppression antenna array element drive signals may comprise generating the suppression antenna array element drive signals based on a covariance matrix calculated from measurements of an interference channel between the suppression antenna array and the receive antenna array and on a covariance matrix calculated from measurements of an interference channel between the transmit antenna array and the receive antenna array and calculating the weight vector which, when applied to the suppression antenna array, causes the compensating electromagnetic field, when superimposed with an electromagnetic field generated by the transmit antenna array, reduces self-interference at the receive antenna array elements.

The generating suppression antenna array element drive signals may comprise generating the suppression antenna array element drive signals based on a covariance matrix calculated from of a matrix of an interference channel between the suppression antenna array and the receive antenna array and on a covariance matrix calculated from of a matrix of an interference channel between the transmit antenna array and the receive antenna array and calculating the weight vector which, when applied to the suppression antenna array, causes the compensating electromagnetic field, when superimposed with an electromagnetic field generated by the transmit antenna array, reduces self-interference at the receive antenna array elements.

The generating suppression antenna array element drive signals may comprise generating the suppression antenna array element drive signals based on a matrix of a channel between the suppression antenna array and the receive antenna array and between the transmit antenna array and the receive antenna array and calculating the weight vector which, when applied partially to the suppression antenna array and partially to the transmit antenna array, causes the suppression antenna array to generate the compensating electromagnetic field and the transmit antenna array to generate a transmit electromagnetic field which, when superimposed, reduces self-interference at the receive antenna array elements.

The generating suppression antenna array element drive signals may comprise generating the suppression antenna array element drive signals based on a covariance matrix calculated from measurements of a channel between the suppression antenna array and the receive antenna array and between the transmit antenna array and the receive antenna array and calculating the weight vector which, when applied partially to the suppression antenna array and partially to the transmit antenna array, causes the suppression antenna array to generate the compensating electromagnetic field and the transmit antenna array to generate a transmit electromagnetic field which, when superimposed, reduces self-interference at the receive antenna array elements.

The generating suppression antenna array element drive signals may comprise generating the suppression antenna array element drive signals based on a covariance matrix calculated from of a matrix of a channel between the suppression antenna array and the receive antenna array and between the transmit antenna array and the receive antenna array and calculating the weight vector which, when applied partially to the suppression antenna array and partially to the transmit antenna array, causes the suppression antenna array to generate the compensating electromagnetic field and the transmit antenna array to generate a transmit electromagnetic field which, when superimposed, reduces self-interference at the receive antenna array elements.

The method may comprise features corresponding to the features of the apparatus set out above.

A computer program comprising instructions stored thereon for performing at least the following: generating suppression antenna array element drive signals for a plurality of suppression antenna array elements of a suppression antenna array of an apparatus comprising a transmit antenna array comprising a plurality of transmit antenna array elements, a receive antenna array comprising a plurality of receive antenna array elements and the plurality of suppression antenna array elements to generate a compensating electromagnetic field to reduce interference received by the plurality of receive antenna array elements from the plurality of transmit antenna array elements.

The computer program may comprise features corresponding to the features of the method set out above.

A non-transitory computer readable medium comprising program instructions stored thereon for performing at least the following: generating suppression antenna array element drive signals for a plurality of suppression antenna array elements of a suppression antenna array of an apparatus comprising a transmit antenna array comprising a plurality of transmit antenna array elements, a receive antenna array comprising a plurality of receive antenna array elements and the plurality of suppression antenna array elements to generate a compensating electromagnetic field to reduce interference received by the plurality of receive antenna array elements from the plurality of transmit antenna array elements.

The non-transitory computer readable medium may comprise features corresponding to the features of the method set out above.

1. An apparatus, comprising:
a transmit antenna array comprising a plurality of transmit antenna array elements;
a receive antenna array comprising a plurality of receive antenna array elements;
a suppression antenna array comprising a plurality of suppression antenna array elements; and
a signal generator configured to generate suppression antenna array element drive signals for said suppression antenna array elements to generate a compensating electromagnetic field to reduce interference received by said plurality of receive antenna array elements from said plurality of transmit antenna array elements.

2. The apparatus of claim 1, wherein said signal generator is configured to generate transmit antenna array element drive signals provided to said plurality of transmit antenna array elements and to generate said suppression antenna array element drive signals from modulated data signals used to generate said transmit antenna array element drive signals.

3. The apparatus of claim 1, wherein said signal generator is configured to generate said suppression antenna array element drive signals by applying a suppression weight vector to said modulated data signals used to generate said transmit antenna array element drive signals.

4. The apparatus of claim 1, wherein said signal generator is configured to one of apply and not apply a modification to a weight vector to said modulated data signals used to generate said transmit antenna array element drive signals.

5. The apparatus of claim 1, wherein said signal generator is configured to generate said suppression antenna array element drive signals based on at least one of the following:
a matrix of a channel between said suppression antenna array and said receive antenna array and on a covariance matrix of a channel between said transmit antenna array and said receive antenna array and to calculate said weight vector which, when applied to said suppression antenna array, causes said compensating electromagnetic field, when superimposed with an electromagnetic field generated by the transmit antenna array, reduces self-interference at said receive antenna array elements.

6. The apparatus of claim 1, wherein said signal generator is configured to generate said suppression antenna array element drive signals based on at least one of the following:
a matrix of a channel between said suppression antenna array and said receive antenna array and between said transmit antenna array and said receive antenna array;
a covariance matrix calculated from measurements of a channel between said suppression antenna array and said receive antenna array and between said transmit antenna array and said receive antenna array; or
a covariance matrix calculated from of a matrix of a channel between said suppression antenna array and said receive antenna array and between said transmit antenna array and said receive antenna array and to calculate said weight vector which, when applied partially to said suppression antenna array and partially to said transmit antenna array, causes said suppression antenna array to generate said compensating electromagnetic field and said transmit antenna array to generate a transmit electromagnetic field which, when superimposed, reduces self-interference at the receive antenna array elements.

7. The apparatus of claim 1, wherein said suppression antenna array element drive signals have a lower power than signals provided to said plurality of transmit antenna array elements.

8. The apparatus of claim 1, wherein said suppression antenna array elements are at least one of the following:
located on said receive antenna array;
located on opposing edges of said receive antenna array;
co-located with said receive antenna array elements;
positioned with said receive antenna array elements;
interposed between said receive antenna array elements;
located on said transmit antenna array;
located an edge of said transmit antenna array closest said receive antenna array;
located away from said transmit antenna array and said receive antenna array; or
located in a space between said transmit antenna array and said receive antenna array.

9. The apparatus of claim 1, wherein said plurality of suppression antenna array elements is no smaller than said plurality of receive antenna array elements.

10. The apparatus of claim 1, wherein said plurality of transmit antenna array elements and said plurality of suppression antenna array elements are a matching number.

11. The apparatus of claim 1, wherein receive antenna array elements of a subarray of said receive antenna array and said plurality of suppression antenna array elements are a matching number.

12. The apparatus of claim 1, wherein said plurality of receive antenna array elements are arranged in an array of a number of rows and columns and said plurality of suppression antenna array elements are arranged in in a matching number of rows and columns.

13. The apparatus of claim 1, wherein said plurality of receive antenna array elements are arranged in an array of a number of rows and a number of columns and said plurality of suppression antenna array elements are arranged in different numbers of rows and columns.

14. The apparatus of claim 1, wherein said plurality of receive antenna array elements are arranged a distance apart and said plurality of suppression antenna array elements are arranged a different distance apart.

15. The apparatus of claim 1, comprising at least one of the following: a wave trap; or electromagnetic shield configured to suppress signals received by said plurality of receive antenna array elements from said plurality of transmit antenna array elements.

16. The apparatus of claim 1, wherein said apparatus comprises a sub-band, non-overlapping, full-duplex antenna assembly.

17. The apparatus of claim 1, wherein the apparatus is a network node device.

18. A method, comprising:
generating suppression antenna array element drive signals for a plurality of suppression antenna array elements of a suppression antenna array of an apparatus comprising a transmit antenna array comprising a plurality of transmit antenna array elements, a receive antenna array comprising a plurality of receive antenna array elements and said plurality of suppression antenna array elements to generate a compensating electromagnetic field to reduce interference received by said plurality of receive antenna array elements from said plurality of transmit antenna array elements.

19. The method of claim 18, comprising generating transmit antenna array element drive signals provided to said plurality of transmit antenna array elements and said generating suppression antenna array element drive signals comprises generating said suppression antenna array element drive signals from modulated data signals used to generate said transmit antenna array element drive signals.

20. The method of claim 18, wherein said generating suppression antenna array element drive signals comprises generating said suppression antenna array element drive signals by applying a suppression weight vector to said modulated data signals used to generate said transmit antenna array element drive signals.

21-23. (canceled)
